(19) United States
(12) Patent Application Publication
(10) Pub. No.: US 2018/0321524 A1
(43) Pub. Date: Nov. 8, 2018

(54) POLYMER-DISPERSED LIQUID CRYSTAL SHUTTER WITH FAST SWITCHING CAPABILITY

(71) Applicant: Fenghua LI, Cupertino, CA (US)

(72) Inventor: Fenghua LI, Cupertino, CA (US)

(21) Appl. No.: 15/973,108

(22) Filed: May 7, 2018

Related U.S. Application Data
(60) Provisional application No. 62/503,205, filed on May 8, 2017.

(51) Int. Cl. G02F 1/1334; G02F 1/137

(52) U.S. Cl. CPC G02F 1/1334; G02F 1/137

(57) ABSTRACT

At least some embodiments of the present disclosure relate to a liquid crystal device. The liquid crystal device includes a first transparent conductor layer, a second transparent conductor layer and a polymer-dispersed liquid crystal (PDLC) layer. The PDLC layer is disposed between the first transparent conductor layer and the second transparent conductor layer. The PDLC layer includes a mixture of a cured polymer material and a plurality of liquid crystal (LC) domains. Each LC domain includes dual-frequency liquid crystal (DFLC) molecules.

### CROSS-REFERENCE TO RELATED APPLICATIONS

This application claims the benefit of and priority to U.S. Provisional Patent Application 62/503,205, filed May 8, 2017, which is incorporated herein by reference in its entirety.

### RELATED FIELD

The present disclosure relates to a liquid crystal shutter, and more particularly to a polymer dispersed liquid crystal shutter with fast switching capability.

### BACKGROUND

Liquid crystals (LCs) have multiple phases that can be distinguished by different optical properties. External influences such as electric fields and/or magnetic fields can cause changes in the macroscopic properties of the liquid crystals. For example, a liquid crystal layer disposed between two crossed polarizers may be utilized as an LC optical switch, which switches between transparent and opaque states based on existence or absence of an electric field. In absence of an electric field, the LC molecules of the liquid crystal layer are at a relaxed phase and reorient incoming light polarized by the first polarizer. The reoriented light transmits through the second polarizer. Thus, the LC optical switch appears transparent. When an electric field is applied, the LC molecules are aligned parallel to the electric field and do not reorient the incoming light polarized by the first polarizer. The second polarizer then absorbs the light due to different polarization directions of the first and second polarizer. Thus, the LC optical switch appears opaque with the application of the electric field.

### BRIEF DESCRIPTION OF THE DRAWINGS

Aspects of the present disclosure are best understood from the following detailed description when read with the accompanying drawings. It is noted that various features may not be drawn to scale, and the dimensions of the various features may be arbitrarily increased or reduced for clarity of discussion.

FIGS. 1A and 1B illustrate an example of a polymer-dispersed liquid crystal (PDLC) shutter device.

FIGS. 2A and 2B illustrate an example of a polymer-dispersed liquid crystal shutter device including dual-frequency liquid crystal.

FIG. 3 illustrates a time response of a normal mode dual-frequency PDLC switch.

FIG. 4 illustrates another time response of a normal mode dual-frequency PDLC switch.

FIGS. 5A and 5B illustrate an example of a reverse mode polymer-dispersed liquid crystal shutter device.

### DETAILED DESCRIPTION

Common reference numerals are used throughout the drawings and the detailed description to indicate the same or similar components. Embodiments of the present disclosure will be readily understood from the following detailed description taken in conjunction with the accompanying drawings.

Various embodiments of the present disclosure are discussed in detail below. It should be appreciated, however, that the embodiments set forth many applicable concepts that can be embodied in a wide variety of specific contexts. It is to be understood that the following disclosure provides many different embodiments or examples of implementing different features of various embodiments. Specific examples of components and arrangements are described below for purposes of discussion. These are, of course, merely examples and are not intended to be limiting.

Embodiments, or examples, illustrated in the drawings, are disclosed below using specific language. It will nevertheless be understood that the embodiments and examples are not intended to be limiting. Any alterations and modifications of the disclosed embodiments, and any further applications of the principles disclosed in this document, as would normally occur to one of ordinary skill in the pertinent art, fall within the scope of this disclosure.

In addition, the present disclosure may repeat reference numerals and/or letters in the various examples. This repetition is for the purpose of simplicity and clarity and does not in itself dictate a relationship between the various embodiments and/or configurations discussed.

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are specified with respect to a certain component or group of components, or a certain plane of a component or group of components, for the orientation of the component(s) as shown in the associated figure. It should be understood that the spatial descriptions used herein are for purposes of illustration only, and that practical implementations of the structures described herein can be spatially arranged in any orientation or manner, provided that the merits of embodiments of this disclosure are not deviated from by such arrangement.

According to at least some embodiments of the present disclosure, liquid crystal devices may include polymer-dispersed liquid crystal (PDLC). In a PDLC device, liquid crystal molecules are dispersed in a liquid polymer. Then the polymer is cured or solidified. During the process that the polymer is cured to change from a liquid stage to a solid stage, the liquid crystal molecules form droplets (also referred to as domains) throughout the polymer. The mixture of the polymer and the liquid crystal may be placed between two transparent layers (e.g., glass or plastic) and form a capacitor in a transparent, conductive thin layer.

An electrical power supply may be attached to electrodes of the LC layer. When no voltage is applied to the electrodes, the liquid crystal molecules are randomly oriented in the droplets and scatter light that passes through the LC layer. Thus, the PDLC device appears translucent or opaque. When a voltage is applied to the electrodes, the electric field causes the liquid crystal molecules to align and to allow light to pass through with no or very little scattering. Thus, the PDLC device appears transparent. The degree of transparency may be controlled by the applied voltage, since the voltage level determines the amount of the crystals being aligned.

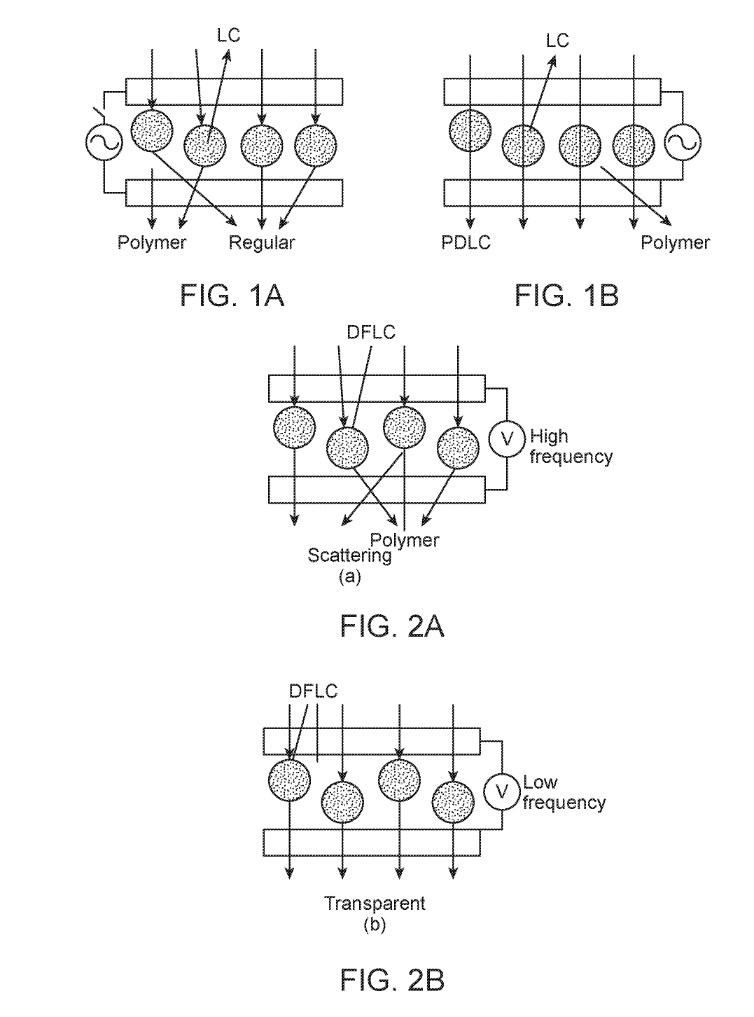

The PDLC device may operate as a shutter (also referred to as optical shutter, shutter device, optical switch, switch device, or switch). FIGS. 1A and 1B illustrate an example of a polymer-dispersed liquid crystal shutter device. As shown in FIG. 1A, when no electric field is applied to the liquid crystal (off state), the liquid crystal molecules of the conventional PDLC scatter the light in various directions. The PDLC shutter device is at a scattering state (e.g., an opaque state or a translucent state). As shown in FIG. 1B, when an electric field is applied to the liquid crystal (on state), the liquid crystal molecules of the conventional PDLC allow the light to pass through without changing the light directions. The PDLC shutter device is at a transparent state.

In some embodiments, the conventional PDLC shutter has a turn-on time Tₒₙ of less than about 20 milliseconds (ms). But the conventional PDLC shutter has a turn-off time T_{off} of longer than about 100 ms. The long turn off time is due to, e.g., liquid crystal having a polydomain structure with many defects in the PDLC. Those defects scatter the light and reduce an overall transmittance rate of the PDLC shutter. The applied voltage induces the defects in a fast way. But once the voltage is no longer applied, the defects diminish in a slow way.

According to at least some embodiments of the present disclosure, a shutter may include a thin film of a polymer-dispersed liquid crystal (PDLC) composition with a polymer material and a dual-frequency liquid crystal (DFLC) material. FIGS. 2A and 2B illustrate an example of a PDLC shutter device including DFLC components (also referred to as dual-frequency PDLC shutter). Each LC droplet of the LC layer includes DFLC molecules. The shutter device may further include a first transparent conductor layer and a second transparent conductor layer that secure the LC thin film layer in between and are electrically coupled to the LC thin film layer.

In some embodiments, the dual-frequency liquid crystal material makes up at least about 60% of a weight of the film. The film may be cured by, e.g., ultraviolet (UV) light exposure. The DFLC components respond to multiple switching frequencies and/or various voltages. The DFLC components may decrease a time for the film to switch between the transparent state and a scattering state. In some embodiments, the LC thin film has a response time equal to or less than about 10 ms.

In some embodiments, an operating voltage of the PDLC shutter including DFLC components is about 50V. In some embodiments, the scattering state of the PDLC shutter including DFLC components has a diffusing function of about 40 degrees. In some embodiments, a design wavelength for the shutter is, e.g., larger than about 1000 nanometers (nm). The shutter may be utilized for, e.g., near-infrared beam control application.

In some embodiments, the dual-frequency PDLC shutter as illustrated in FIGS. 2A and 2B is opaque when no voltage is applied. When a voltage is applied, the dual-frequency PDLC shutter may be opaque (or translucent) or transparent, depending on the switching frequency.

In some embodiments, at a room temperature, the DFLC material has a low crossover frequency of about 1 KHz. The PDLC shutter may be switched between the transparent and scattering states at frequencies of, e.g., 50 Hz and 3 KHz. In some embodiments, the DFLC material may exhibit a positive dielectric anisotropy (Delta epsilon>0) at a low frequency (e.g., 50 Hz) and may exhibit a negative dielectric anisotropy (Delta epsilon <0) at a high frequency (e.g., 3 KHz).

As shown in FIG. 2A, at a high switching frequency (e.g., 3 KHz), the liquid crystal molecules of the dual-frequency PDLC shutter are aligned horizontally due to the negative dielectric anisotropy. Thus, dual-frequency PDLC shutter is at a scattering state (e.g., an opaque state) at the high frequency. As shown in FIG. 2B, at a low switching frequency (e.g., 50 Hz), the liquid crystal molecules of the dual-frequency PDLC shutter are aligned vertically due to the positive dielectric anisotropy. Thus, dual-frequency PDLC shutter is at a transparent state at the low frequency.

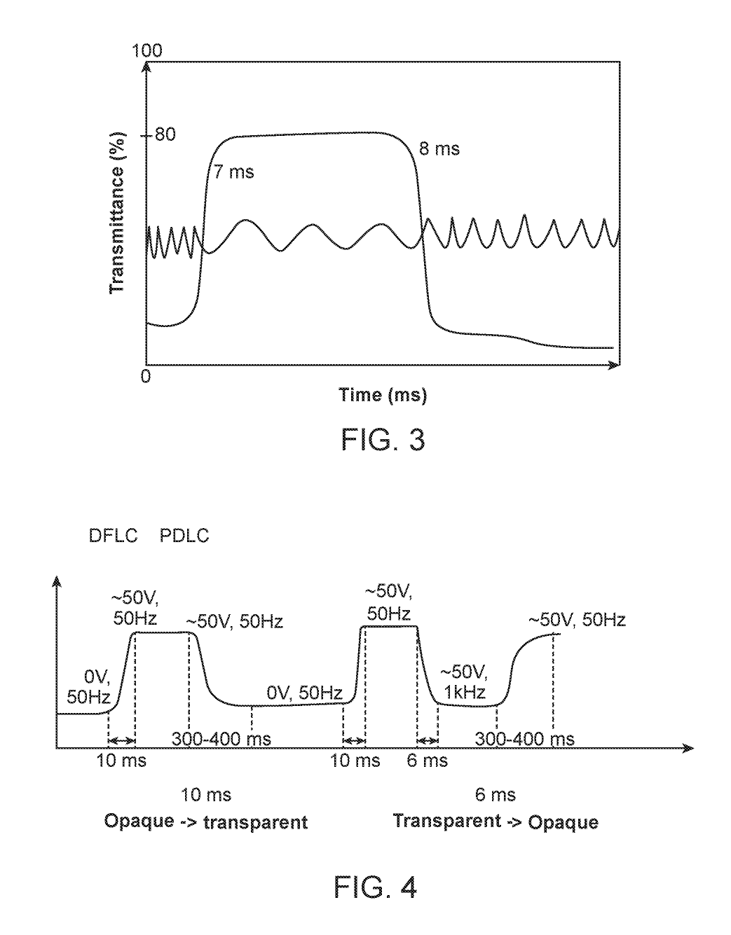

The normal mode dual-frequency PDLC shutter may have a short response time. FIG. 3 illustrates a time response of a normal mode dual-frequency PDLC switch. For example, in some embodiments, the dual-frequency PDLC shutter may have a turn-on time Tₒₙ of less than about 10 ms. The dual-frequency PDLC shutter may also have a turn-off time T_{off} of less than about 10 ms.

FIG. 4 illustrates another time response of a normal mode dual-frequency PDLC switch. As shown in FIG. 4, the switching from a scattering state (e.g., an opaque state) at 50V and 1 KHz to a transparent state at 50V at 50 Hz is relatively slow. The switching may achieve a faster rate of switching from the scattering state to the transparent state, by switching off the voltage (0V) and then switching from a stage at, e.g., 0V 50 Hz to another stage at, e.g., 50V 50 Hz. The switching from a transparent state at a low frequency (e.g., 1 KHz) to a scattering state (e.g., an opaque state) at a high frequency (e.g., 50 Hz) has also a short response time. Therefore, the dual-frequency PDLC switch has fast turn-on time Tₒₙ and turn-off time T_{off} and can achieve a fast dual-frequency addressing.

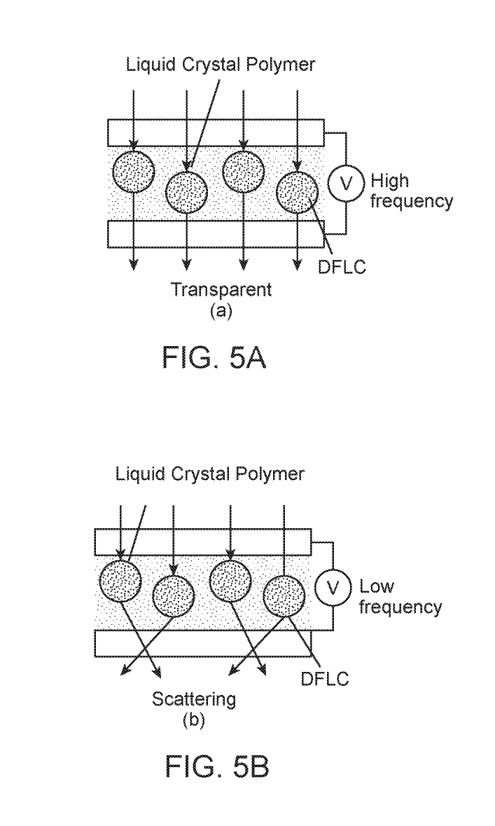

According to at least some embodiments of the present disclosure, a shutter may be a reverse mode PDLC shutter device. FIGS. 5A and 5B illustrate an example of a reverse mode PDLC shutter device. Different from the PDLC shutter device as shown in FIGS. 2A and 2B, the reverse mode PDLC shutter device includes a plurality of liquid crystal polymers that have been aligned horizontally already, as shown FIGS. 5A and 5B.

In some embodiments, the reverse mode PDLC shutter device may be more transparent (e.g., having a higher transparency rate or a higher transmittance rate) than a normal model PDLC shutter device, because the birefringence of polymer matches with liquid crystal domains. The reverse mode PDLC shutter device includes a thin film of a PDLC composition. The PDLC composition includes a liquid crystal polymer material and a dual-frequency liquid crystal (DFLC) material. In some embodiments, the dual-frequency liquid crystal (DFLC) material makes up at least about 60% of a weight of the film.

The polymer may be aligned via, e.g., a surface treatment. The film is cured by, e.g., UV light exposure. The DFLC components respond to multiple switching frequencies and/or various voltages. The DFLC components may decrease a time for the film to switch between the transparent state and a scattering state. In some embodiments, the LC thin film has a response time equal to or less than about 10 ms.

The shutter device may further include a first transparent conductor layer and a second transparent conductor layer that secure the LC thin film layer in between and are electrically coupled to the LC thin film layer.

In some embodiments, an operating voltage of the PDLC shutter including DFLC components is about 50V. In some embodiments, the scattering state of the PDLC shutter including DFLC components has a diffusing function of about 40 degrees. In some embodiments, a design wavelength for the shutter is, e.g., larger than about 1000 nanometers (nm). The shutter may be utilized for, e.g., near-infrared beam control application.

In some embodiments, the reverse mode dual-frequency PDLC shutter as illustrated in FIGS. 5A and 5B is opaque when no voltage is applied. When a voltage is applied, the reverse mode dual-frequency PDLC shutter may be opaque (or translucent) or transparent, depending on the switching frequency.

In some embodiments, at a room temperature, the DFLC material has a low crossover frequency of about 1 KHz. The PDLC shutter may be switched between the transparent and scattering states at frequencies of, e.g., 50 Hz and 3 KHz. In some embodiments, the DFLC material may exhibit a positive dielectric anisotropy (Delta epsilon>0) at a low frequency (e.g., 50 Hz) and may exhibit a negative dielectric anisotropy (Delta epsilon <0) at a high frequency (e.g., 3 KHz).

The reverse mode PDLC shutter device may have a reversed switching behavior, compared to a normal mode PDLC shutter device (e.g., as shown in FIGS. 2A and 2B). As shown in FIG. 5A, at a high switching frequency (e.g., 3 KHz), the liquid crystal molecules of the reverse mode dual-frequency PDLC shutter are aligned horizontally due to the negative dielectric anisotropy. Due to the existence of the liquid crystal polymers that are aligned horizontally, the reverse mode dual-frequency PDLC shutter is at a transparent state at the high frequency. As shown in FIG. 5B, at a low switching frequency (e.g., 50 Hz), the liquid crystal molecules of the reverse mode dual-frequency PDLC shutter are aligned vertically due to the positive dielectric anisotropy. Due to the existence of the liquid crystal polymers that are aligned horizontally, reverse mode dual-frequency PDLC shutter is at a scattering state (e.g., an opaque state) at the low frequency.

As used herein and not otherwise defined, the terms “substantially,” “substantial,” “approximately” and “about” are used to describe and account for small variations. When used in conjunction with an event or circumstance, the terms can encompass instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, two numerical values can be deemed to be “substantially” the same or equal if a difference between the values is less than or equal to ±10% of an average of the values, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

As used herein, the singular terms “a,” “an,” and “the” may include plural referents unless the context clearly dictates otherwise. In the description of some embodiments, a component provided “on” or “over” another component can encompass cases where the former component is directly on (e.g., in physical contact with) the latter component, as well as cases where one or more intervening components are located between the former component and the latter component.

Amounts, ratios, and other numerical values are sometimes presented herein in a range format. It can be understood that such range formats are used for convenience and brevity, and should be understood flexibly to include not only numerical values explicitly specified as limits of a range, but also all individual numerical values or sub-ranges encompassed within that range as if each numerical value and sub-range is explicitly specified.

While the present disclosure has been described and illustrated with reference to specific embodiments thereof, these descriptions and illustrations are not limiting. It should be understood by those skilled in the art that various changes may be made and equivalents may be substituted without departing from the true spirit and scope of the present disclosure as defined by the appended claims. The illustrations may not necessarily be drawn to scale. There may be distinctions between the artistic renditions in the present disclosure and the actual apparatus due to manufacturing processes and tolerances. There may be other embodiments of the present disclosure which are not specifically illustrated. The specification and the drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations.

What is claimed is:

1. A liquid crystal device, comprising:
a first transparent conductor layer;
a second transparent conductor layer; and
a polymer-dispersed liquid crystal (PDLC) layer disposed between the first transparent conductor layer and the second transparent conductor layer, the PDLC layer including:
a cured polymer material, and
a plurality of liquid crystal (LC) domains, each LC domain including dual-frequency liquid crystal (DFLC) molecules.

2. The liquid crystal device of claim 1, further comprising:
a power supply electrically coupled to the first transparent conductor layer and the second transparent conductor layer, the power supply configured to apply an electric field to the PDLC layer at a first voltage and a second voltage with a first switching frequency and a second switching frequency, the first voltage higher than the second voltage, the first switching frequency higher than the second switching frequency.

3. The liquid crystal device of claim 2, wherein the PDLC layer is at an opaque state when the power supply applies the electric field with the first switching frequency, and the PDLC layer is at a transparent state when the power supply applies the electric field with the second switching frequency.

4. The liquid crystal device of claim 2, wherein the second voltage is zero voltage.

5. The liquid crystal device of claim 2, wherein the power supply is configured to switch the PDLC layer from an opaque state to a transparent state by a process including:
applying the electric field at the first voltage with the first switching frequency;
applying the electric field at the second voltage; and
applying the electric field at the first voltage with the second switching frequency.

6. The liquid crystal device of claim 2, wherein the PDLC layer is in a reversed dual-frequency mode, the PDLC layer is at an opaque state when the power supply applies the electric field with the second switching frequency, and the PDLC layer is at a transparent state when the power supply applies the electric field with the first switching frequency.
